(19) United States
(12) Patent Application Publication
(10) Pub. No.: US 2013/0121788 A1
(43) Pub. Date: May 16, 2013

(54) Bicycle Tooth Plate Rivet

(71) Applicant: Chuan Li Precise Industries Co., Ltd., Taichung City (TW)

(72) Inventor: PING-CHOU YU, Taichung City (TW)

(73) Assignee: CHUAN LI PRECISE INDUSTRIES CO., LTD., Taichung City (TW)

(21) Appl. No.: 13/666,975

(22) Filed: Nov. 2, 2012

(30) Foreign Application Priority Data
Nov. 15, 2011 (TW) 100221551

(51) Int. Cl. F16B 19/04

(52) U.S. Cl. 411/501

(57) ABSTRACT

The present invention provides an improved bicycle tooth plate rivet comprising a metal shaft; and wherein the metal shaft comprises a first shaft section and a second shaft section. The first shaft section is forged to form a rivet head and the second shaft section is attached to the bottom of the rivet head to form a rivet rod such that the hardness of the rivet head is advantageously greater than the one of the rivet rod.

### TECHNICAL FIELD OF THE INVENTION

The present invention is related to an improved bicycle tooth plate rivet, in particular, to a rivet with an irregular head or similar structural configuration applicable to the tooth plates of bicycles or electric bicycles.

### DESCRIPTION OF THE PRIOR ART

Bicycles are well known for their merits of being clean and energy-saving among various types of vehicles built for transportation. With regard to the growing awareness in the environmental issues, in particular, bicycles are becoming more popular than ever. There are mainly two types of bicycles including fixed-gear bicycles and variable-gear bicycles. For variable-gear bicycles, as an example, the large and small tooth plates of the front derailleur are of different numbers of tooth that varies from each other greatly; for instance, the height of the large can be significantly different from the one of the small tooth plate as being three or four times greater. Therefore, to ensure that the gear chain can be successfully shifted up from the smaller tooth plate to the larger tooth plate during its operation, a supporting structure is commonly used, as a conventional technique, to facilitate the shifting of the gear chain of the bicycle. Such conventionally technique usually requires the use of additional rivets as the supporting structure by soldering or riveting additional rivets at proper locations predefined on one side of the larger tooth plate facing the smaller tooth plate. With such structural configuration, the rivet heads abut against the outer chain board of the gear chain during the shifting up of the gear chain such that the gear chain can be lifted upward during the rotation of the tooth plate to effectively assist the shifting of the gear chain.

Nevertheless, due to the drawback of having a uniform hardness for both the parts of the rivet head and the rivet rod of a single rivet, the rivet head is extremely vulnerable to wearing outs and damages while being constantly subject to greater loads during its operation. As a result, when the gear chain is under greater loads or external forces, the gear chain is likely to slip off from the rivets, which greatly reduces the successful rate of having the gear chain being properly supported and affects the effectiveness of gear shifting.

Furthermore, once the gear chain are prone to slip off from the rivet heads, the rivet heads are more likely to be damaged and worn out and at a much faster rate, which would too lead to unfavorable outcomes.

In view of the above drawbacks associated with the conventionally bicycle tooth plate rivets, after years of research and development, the inventor aims to provide an improved bicycle tooth plate rivet having a rivet head with an increased hardness to effectively prevent or significantly reduce the wearing outs of the bicycle tooth plate rivets such that it is optimal for assembly or manufacturing and is convenient to the use of the public in the field.

### SUMMARY OF THE INVENTION

A primary objective of the present invention is to provide an improved bicycle tooth plate rivet with an increased hardness to effectively reduce or prevent wearing outs and damages thereof.

To achieve the abovementioned objective, an improved bicycle tooth plate rivet of the present invention comprises a metal shaft and is characterized in that the metal shaft comprises a first shaft section and a second shaft section; wherein the first shaft section is forged to form a rivet head, and the second shaft section forming a rivet rod is attached to a bottom of the rivet head; and wherein the rivet rod is formed via a cooling process in a cooling tank and the rivet head is formed via a heat treating process such that a hardness of the rivet head is greater than another hardness of the rivet rod of the rivet.

According to the abovementioned improved bicycle tooth plate rivet, wherein the first shaft section being forged is formed via a cold forging process.

According to the abovementioned improved bicycle tooth plate rivet, wherein the rivet head is forged to form a predefined shape with a lathe.

According to the abovementioned improved bicycle tooth plate rivet, wherein the metal shaft is a martensite.

According to the abovementioned improved bicycle tooth plate rivet, wherein the heat treating process is a high-frequency induction heating process.

According to the abovementioned improved bicycle tooth plate rivet, wherein the cooling tank of the cooling process comprises a cooling water or a coolant.

According to the abovementioned improved bicycle tooth plate rivet, wherein the metal shaft is heated before the rivet head is placed within a cooling tank, followed by an annealing process performed on the rivet rod.

In comparison to the known arts, the improved bicycle tooth plate rivet exhibits the following merits of:
1. having two different hardness configured in one single rivet such that upon its assembly onto the bicycle tooth plate, the rivet head thereof with a greater hardness is durable to the wearing outs caused by the gear chain; and
2. utilizing the rivet rod with a lower hardness for a riveted attachment onto the tooth plate such that the tooth plate is protected from mechanical deformation.

### BRIEF DESCRIPTION OF THE DRAWINGS

FIG. 1 is a perspective view of the first embodiment of the present invention;

FIG. 2 is a manufacturing block diagram of the first embodiment of the present invention;

FIG. 3 is a manufacturing block diagram of the second embodiment of the present invention;

FIG. 4 is an illustration showing the state of use of the embodiment of the present invention; and

FIG. 5 is a manufacturing block diagram of the third embodiment of the present invention.

### DETAILED DESCRIPTION OF THE PREFERRED EMBODIMENTS

The details of the preferred embodiments of the present invention are further provided below for illustrative purposes only to demonstrate the principles of the present invention.

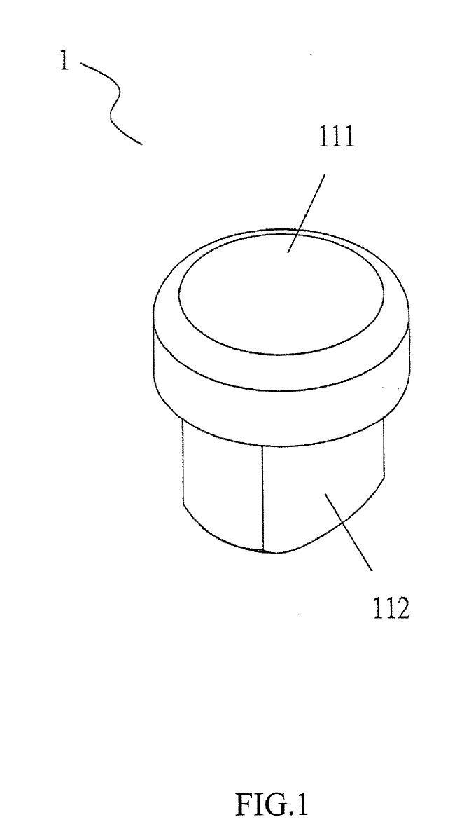

As shown in FIG. 1, the present invention provides an improved bicycle tooth plate rivet 1, comprising a metal shaft 11 and characterized in that the metal shaft 11 comprises a first shaft section and a second shaft section; wherein the first shaft section is forged to form a rivet head 111 with a forging machine 2, and the second shaft section forming a rivet rod 112 is attached to a bottom of the rivet head 111. Therefore, as the first shaft section is being forged by the forging machine 2 to undergo a mechanical property change with respect to its shape and density, the hardness of the rivet head 111 is increased while the mechanical property of the rivet rod 112 of the second shaft section is remained and unchanged such that the improved rivet 1 of the present invention is one with a harder head portion and a softer rod portion.

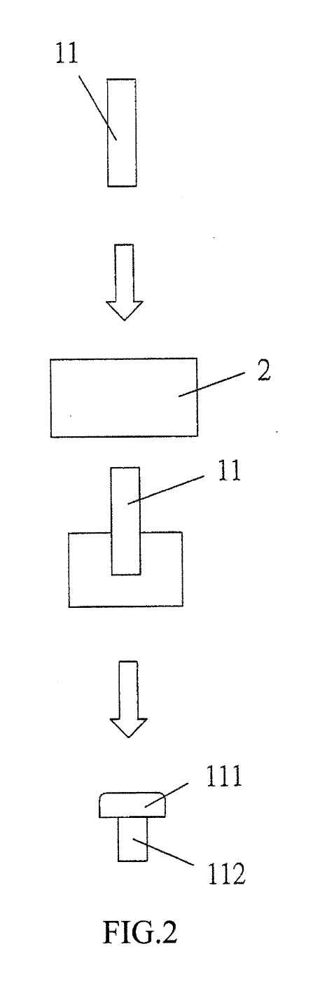

As shown in FIG. 2, the second shaft section of the metal shaft 11 is positioned beneath the forging head of the forging machine 2. Once the forging machine 2 is turned on, the first shaft section of the metal shaft 11 is subject to a pressurized impact causing it to form a rivet head 111 as a central protrusion with a large surface area; whereas the second shaft section is attached to the center of the bottom of the rivet head 111 to form a rivet rod 112. Due to the forging impact, the first shaft section can be formed to be of a desired shape with a different density, and as a result, the rivet is formed to have different densities for different parts such that a hardness of the rivet head 111 is greater than another hardness of the rivet rod 112.

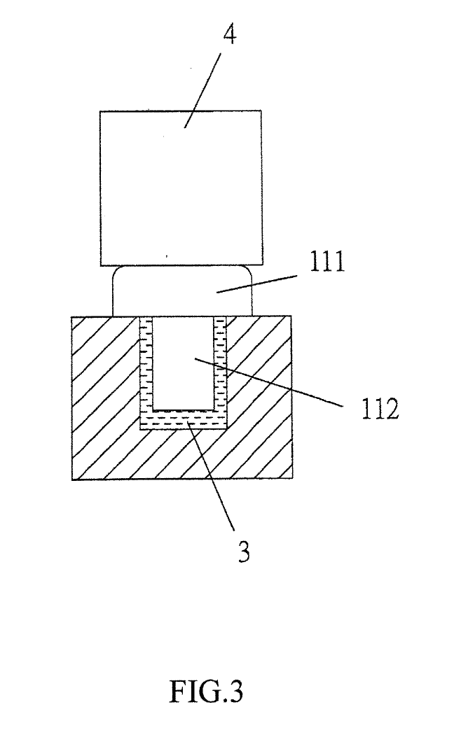

As shown in FIG. 3, in a second embodiment of the present invention, an improved bicycle tooth plate rivet 1 comprises a rivet head 111 and a rivet rod 112, and wherein the rivet rod 112 is formed via a cooling process with a cooling tank 3 and the rivet head 111 is formed via a heating process 4. The heating process 4 can be a high-frequency induction heating process or a flame heating process such that the rivet head 111 is being impacted to deform in its shape and density followed by the heating process 4 in order to further increase the hardness of the rivet head 111 as a second increase thereof without affecting the hardness of the rivet rod 112 and such that the rivet 1 is formed to be of different parts of a harder head portion and a softer rod portion.

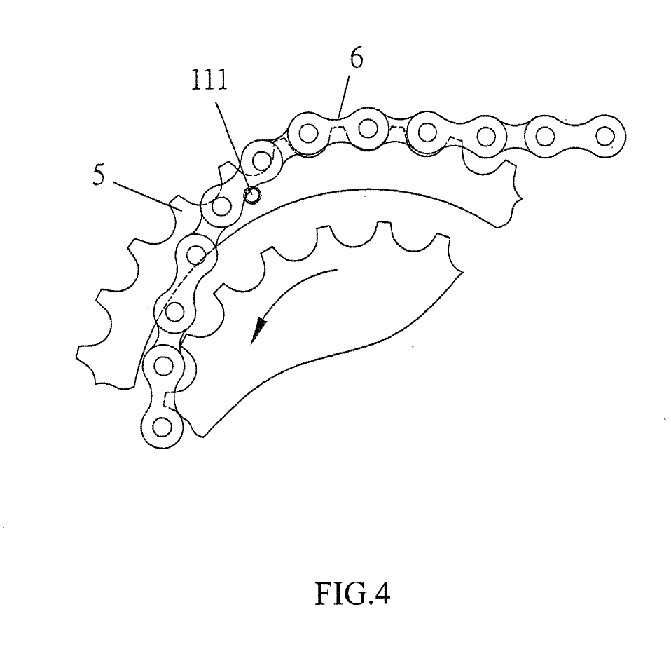

As shown in FIG. 4, the improved rivet of the present invention can be assembled onto a large tooth plate 5 of a bicycle gear transmission system. Since the rivet rod 112 is of a hardness softer than the one of the rivet head 111, once the rivet is mounted onto the through-hole of the large tooth plate 5 via a riveted attachment, the large tooth plate 5 is prevented from deformation and the rivet head 111 with an increased hardness is also protected from wearing outs caused by the gear chain 6 and the friction therebetween.

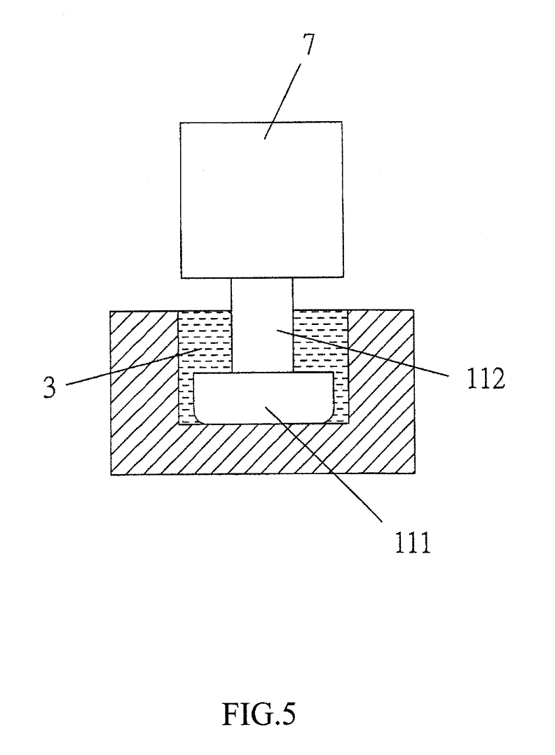

As shown in FIG. 5, in a third embodiment of the present invention, an improved rivet 1 comprises a rivet head 111 and a rivet rod 112; and wherein the improved rivet 1 is being heated or undergoes a heat treatment first prior to the placement of the rivet head 111 into a cooling tank 3, which is then followed by an annealing process 7 performed on the rivet rod 112. The annealing process 7 is a heat treatment at a lower temperature such that the rivet rod 112 is soften by heating at a lower temperature without affecting the hardness of the rivet head 111 in order to form an improved rivet 1 with different parts having different hardness and such that the improved rivet 1 of the present invention is of a harder head portion and a softer rod portion.

What is claimed is:

1. An improved bicycle tooth plate rivet, comprising a metal shaft, and characterized in that: said metal shaft comprises a first shaft section and a second shaft section; wherein said first shaft section is forged to form a rivet head, and said second shaft section forming a rivet rod is attached to a bottom of said rivet head; and wherein said rivet rod is formed via a cooling process in a cooling tank and said rivet head is formed via a heat treating process such that a hardness of said rivet head is greater than another hardness of said rivet rod of said rivet.

2. The improved bicycle tooth plate rivet according to claim 1, wherein said first shaft section being forged is formed via a cold forging process.

3. The improved bicycle tooth plate rivet according to claim 1, wherein said rivet head is forged to form a predefined shape with a lathe.

4. The improved bicycle tooth plate rivet according to claim 1, wherein said metal shaft is a martensite.

5. The improved bicycle tooth plate rivet according to claim 1, wherein said heat treating process is a high-frequency induction heating process or a flame heating process.

6. The improved bicycle tooth plate rivet according to claim 1, wherein said cooling tank of said cooling process comprises a cooling water or a coolant.

7. The improved bicycle tooth plate rivet according to claim 1, wherein said metal shaft is heated before said rivet head is placed into a cooling tank, followed by an annealing process performed on said rivet rod.
